(19) United States
(12) Patent Application Publication
(10) Pub. No.: US 2014/0074827 A1
(43) Pub. Date: Mar. 13, 2014

(54) AUTOMATED PREDICTIVE SCORING IN EVENT COLLECTION

(71) Applicants: Christopher Ahlberg, Watertown, MA (US); Bill Ladd, Cambridge, MA (US); Evan Sparks, Cambridge, MA (US)

(72) Inventors: Christopher Ahlberg, Watertown, MA (US); Bill Ladd, Cambridge, MA (US); Evan Sparks, Cambridge, MA (US)

(21) Appl. No.: 13/684,472

(22) Filed: Nov. 23, 2012

Related U.S. Application Data
(60) Provisional application No. 61/563,528, filed on Nov. 23, 2011.

(51) Int. Cl. G06F 17/30

(52) U.S. Cl. CPC G06F 17/30011
USPC 707/723; 707/758

(57) ABSTRACT

Disclosed, in one general aspect, is a computer-based method and apparatus for extracting predictive information from a collection of stored, machine-readable electronic documents. The method includes accessing at least a subset of the electronic documents each including different machine-readable predictive information about one or more future facts occurring after a publication time for that document. The method also includes extracting the predictive information about the one or more future facts from the accessed documents, acquiring verified information about one or more of the facts, and evaluating a measure of quality of the predictive information extracted from the documents based on the verified information about the facts.

### CROSS-REFERENCE TO RELATED APPLICATION

This application claims the benefit under 35 U.S.C. 119(e) of U.S. provisional application Ser. No. 61/563,528 filed Nov. 23, 2011, which is herein incorporated by reference. This application is related to U.S. Application Serial Nos. 20100299324 and 20090132582 both entitled Information Service for Facts Extracted from Differing Sources on a Wide Area Network as well as to U.S. Application Ser. No. 61/550,371 and Ser. No. 13/657825 both entitled Search Activity Prediction, which are all herein incorporated by reference.

### FIELD OF THE INVENTION

This invention relates to methods and apparatus for scoring media sources, including methods and apparatus that dynamically and automatically score media sources on their ability to predict events for each of a number of event types

### BACKGROUND OF THE INVENTION

The above-referenced applications provide a system for predicting facts from sources such as internet news sources. For example, where an article references a scheduled future fact in a textually described prediction, such as “look for a barrage of shareholder lawsuits against Yahoo next week,” the system can map the lawsuit fact to a “next week” timepoint. Deriving occurrence timepoints from content meaning through linguistic analysis of textual sources in this way can allow users to approach temporal information about facts in new and powerful ways, enabling them to search, analyze, and trigger external events based on complicated relationships in their past, present, and future temporal characteristics. For example, users can use the extracted occurrence timepoints to answer the following questions that may be difficult to answer with traditional search engines:

What will the pollen situation be in Boston next week?

Will terminal five be open next month?

What's happening in New York City this week?

When will movie X be released?

When is the next SARS conference?

When is Pfizer issuing debt next?

Where Will George Bush be next week? (see page 8, paragraphs 2-3)

### BRIEF DESCRIPTION OF THE DRAWINGS

FIG. 1 shows an illustrative automated predictive scoring system according to the invention; and

FIG. 2 is a flowchart for the illustrative automated predictive scoring system according to the invention.

### SUMMARY OF THE INVENTION

In one general aspect, the invention features a computer-based method for extracting predictive information from a collection of stored, machine-readable electronic documents that includes accessing at least a subset of the electronic documents each including different machine-readable predictive information about one or more future facts occurring after a publication time for that document, and each with an identified source. The method includes extracting the predictive information about the one or more future facts from the accessed documents, acquiring verified information about one or more of the facts, and evaluating a measure of quality of the predictive information extracted from the documents based on the verified information about the facts.

In preferred embodiments the method can further include the step of associating a result of the step of evaluating for each of the documents with its corresponding document. The method can further include the step of associating a result of the step of evaluating for each of the documents with a source for its corresponding document. The step of associating can update a speed-of-prediction score for at least one of the sources. The step of associating can update a quality-of-prediction score for at least one of the sources. The steps of accessing, extracting, acquiring, evaluating, and associating can be repeated for a number of documents from a number of sources to derive and continuously update a set of scores for a plurality of sources. The method can further include the step of deriving a likelihood measure for at least one future event based on a set of predictions by different sources and the scores of those sources. The step of extracting can employ natural language processing by a computer. The step of accessing can access documents before the facts that they predict occur, with the documents being associated with a publication time that includes a machine-readable publication date, and with the step of evaluating updating a ranking of sources. The step of evaluating can evaluates a measure of how well a source is followed by other sources with the step of updating a ranking updating a ranking based on this measure. The step of evaluating can evaluate a measure of how quickly a source predicts a fact with the step of updating a ranking updating a ranking based on this measure. The step of evaluating can evaluate whether sources predict facts first with the step of updating a ranking updating a ranking based on this measure. The step of acquiring verified information about one or more of the facts can acquire verified information that includes if the facts did occur, and if so when. The steps of accessing, extracting, acquiring, and evaluating can be performed for a number of different groups of sources of different types.

In another general aspect, the invention features a computer-based apparatus for extracting predictive information from a collection of stored, machine-readable electronic documents from a plurality of different sources. The apparatus includes an interface for accessing at least a subset of the electronic documents each including different machine-readable predictive information about one or more future facts occurring after a publication time for that document, and each with an identified source, a predictive information extraction subsystem operative to extract predictive information about the one or more future facts from the documents accessed by the interface, and a source ranker responsive to verified information about one or more facts about which information is included in documents from a plurality of the sources and being operative to provide a measure of source quality to the predictive information extraction subsystem.

In preferred embodiments, the source ranker can provide a speed-of-prediction score for at least one of the sources. The source ranker can provide a quality-of-prediction score for at least one of the sources. The source ranker can be operative to derive and continuously update a set of scores for a plurality of sources. The predictive information extraction subsystem can employ natural language processing by a computer. The source ranker can be operative to evaluate a measure of how well a source is followed by other sources. The source ranker can be operative to evaluate a measure of how quickly a source predicts a fact. The source ranker can be operative to evaluate whether sources predict facts first. The source ranker can be operative to evaluate a number of different groups of sources of different types.

In a further general aspect, the invention features a computer-based apparatus for extracting predictive information from a collection of stored, machine-readable electronic documents from a plurality of different sources. The apparatus includes means for accessing at least a subset of the electronic documents each including different machine-readable predictive information about one or more future facts occurring after a publication time for that document, and each with an identified source, means for extracting the predictive information about the one or more future facts from the accessed documents, means for acquiring verified information about one or more of the facts, and means for evaluating a measure of quality of the predictive information extracted from the documents based on the verified information about the facts.

### DETAILED DESCRIPTION OF AN ILLUSTRATIVE EMBODIMENT

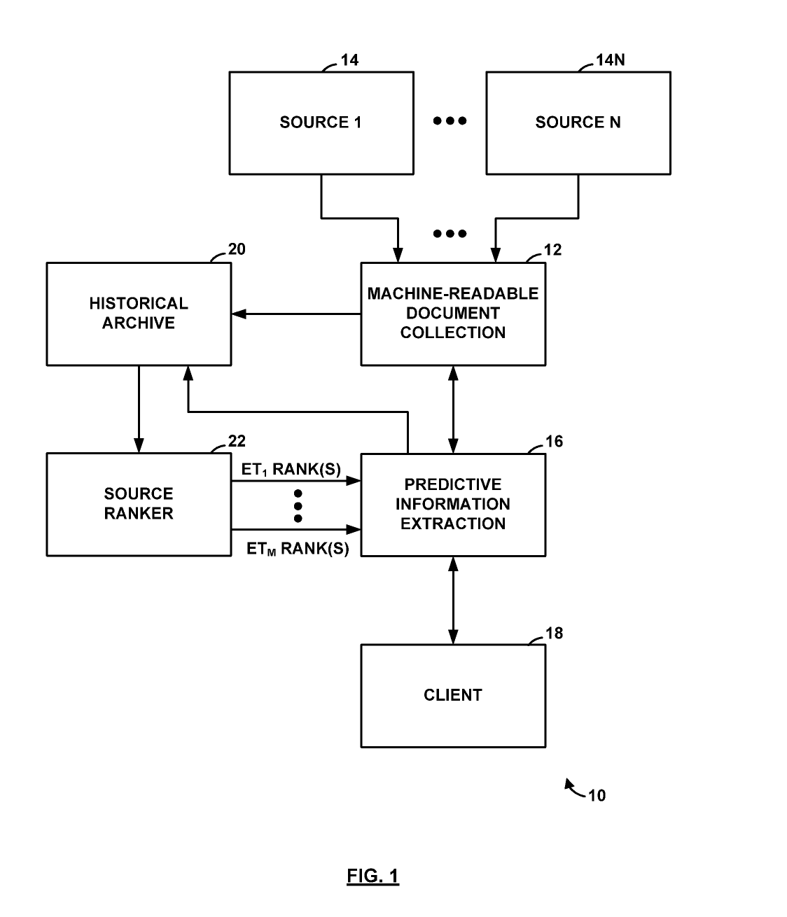

Systems according to one aspect of the invention help to optimize systems that extract predictive information from sources such as textual documents by scoring media sources on their ability to predict events. Referring to FIG. 1, an illustrative automated predictive scoring system 10 according to the invention includes a predictive information extraction subsystem. This subsystem can perform extraction from a machine-readable collection of documents 12 populated by a plurality of different sources 14 . . . 14N in a number of ways, including those presented in the above-referenced applications. In one embodiment the Recorded Future API is used. This system provides a live updated dataset of computationally extracted, canonical and clustered, events (i.e. meaningfully grouping multiple reporting on the same events) from many media sources and across many types for one or more clients 18.

The canonical and clustered events correspond to “real world events,” broken down by appropriate time period. I.e., all the natural disaster reports around Hurricane Irene can become grouped into a event cluster. Below such clustered/canonical events are for simplicity referred to as events.

Some sources (newspapers, blog, government sites, etc) are presumably consistently “better” at predicting events than others. Validated events are events that have been validated through a process including human curation/validation (experts, crowd, etc.). To be “good/better” at prediction can carry potentially different meanings, for example:

a. Being first to report upon validated events
A human validates the dates of say all Apple product release events, and presumably some source is first more than others in predicting (i.e. first to report) those dates.

b. Being first to initiate clusters (i.e. break news stories)
An algorithm creates clusters (per above) of events, and again, presumably some source more than others initiate/break those events (i.e. first to report!)
   a) and b) above could be the same, but one difference is that one is unlikely to have mass validation of millions of events, and algorithmic event cluster (if done well) can be a good proxy for validated events.

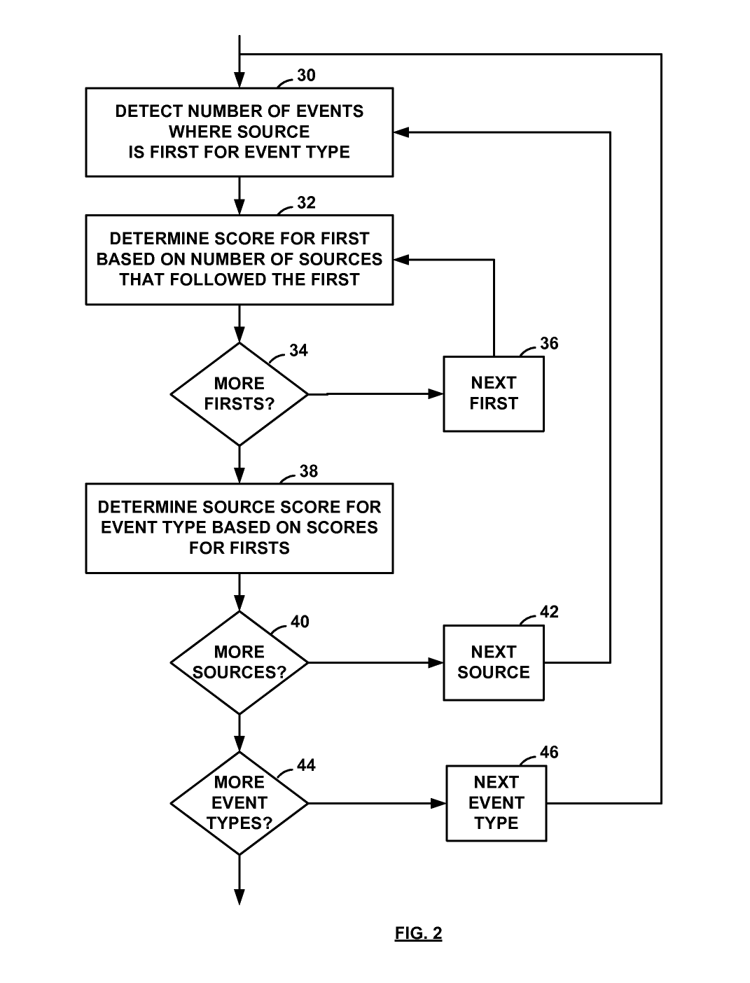

Referring to FIG. 2, the illustrative automated predictive scoring system 10 uses a source ranker 22 that accesses a historical archive 20 and employs the following illustrative approach:

Execute the below on historical archive
For each source (S) and each event type (ET) assume an initial predictive score (PS) of 0
For each ET
   For each source S
      Determine how many events E where S is first (step 30)
      Determine the total number of other sources that “followed” S in each E (step 32)
      The score for each first is the number of followers (or some related measure)
      The total score for S for each event type ET is the sum of followers for each first (step 38)

Sort all sources S for each ET, rank ordered by PS, and normalize PS from 0-100

The system described above has been implemented in connection with special-purpose software programs running on general-purpose computer platforms, but it could also be implemented in whole or in part using special-purpose hardware. And while the system can be broken into the series of modules and steps shown for illustration purposes, one of ordinary skill in the art would recognize that it is also possible to combine them and/or split them differently to achieve a different breakdown, and that the functions of such modules and steps can be arbitrarily distributed and intermingled within different entities, such as routines, files, and/or machines. Moreover, different providers can develop and operate different parts of the system.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is

1. A computer-based method for extracting predictive information from a collection of stored, machine-readable electronic documents, comprising:
accessing at least a subset of the electronic documents each including different machine-readable predictive information about one or more future facts occurring after a publication time for that document, and each with an identified source,
extracting the predictive information about the one or more future facts from the accessed documents,
acquiring verified information about one or more of the facts, and
evaluating a measure of quality of the predictive information extracted from the documents based on the verified information about the facts.

2. The method of claim 1 further including the step of associating a result of the step of evaluating for each of the documents with its corresponding document.

3. The method of claim 1 further including the step of associating a result of the step of evaluating for each of the documents with a source for its corresponding document.

4. The method of claim 3 wherein the step of associating updates a speed-of-prediction score for at least one of the sources.

5. The method of claim 3 wherein the step of associating updates a quality-of-prediction score for at least one of the sources.

6. The method of claim 3 wherein the steps of accessing, extracting, acquiring, evaluating, and associating are repeated for a number of documents from a number of sources to derive and continuously update a set of scores for a plurality of sources.

7. The method of claim 6 further including the step of deriving a likelihood measure for at least one future event based on a set of predictions by different sources and the scores of those sources.

8. The method of claim 1 wherein the step of extracting employs natural language processing by a computer.

9. The method of claim 1 wherein the step of accessing accesses documents before the facts that they predict occur, wherein the documents are associated with a publication time that includes a machine-readable publication date, and wherein the step of evaluating updates a ranking of sources.

10. The method of claim 9 wherein the step of evaluating evaluates a measure of how well a source is followed by other sources and wherein the step of updating a ranking updates a ranking based on this measure.

11. The method of claim 9 wherein the step of evaluating evaluates a measure of how quickly a source predicts a fact and wherein the step of updating a ranking updates a ranking based on this measure.

12. The method of claim 9 wherein the step of evaluating evaluates whether sources predict facts first and wherein the step of updating a ranking updates a ranking based on this measure.

13. The method of claim 1 wherein the step of acquiring verified information about one or more of the facts acquires verified information that includes if the facts did occur, and if so when.

14. The method of claim 1 wherein the steps of accessing, extracting, acquiring, and evaluating are performed for a number of different groups of sources of different types.

15. A computer-based apparatus for extracting predictive information from a collection of stored, machine-readable electronic documents from a plurality of different sources, comprising:
an interface for accessing at least a subset of the electronic documents each including different machine-readable predictive information about one or more future facts occurring after a publication time for that document, and each with an identified source,
a predictive information extraction subsystem operative to extract predictive information about the one or more future facts from the documents accessed by the interface, and
a source ranker responsive to verified information about one or more facts about which information is included in documents from a plurality of the sources and being operative to provide a measure of source quality to the predictive information extraction subsystem.

16. The apparatus of claim 15 wherein the source ranker provides a speed-of-prediction score for at least one of the sources.

17. The apparatus of claim 15 wherein the source ranker provides a quality-of-prediction score for at least one of the sources.

18. The apparatus of claim 15 wherein the source ranker is operative to derive and continuously update a set of scores for a plurality of sources.

19. The apparatus of claim 15 wherein the predictive information extraction subsystem employs natural language processing by a computer.

20. The apparatus of claim 15 wherein the source ranker is operative to evaluate a measure of how well a source is followed by other sources.

21. The apparatus of claim 15 wherein the source ranker is operative to evaluate a measure of how quickly a source predicts a fact.

22. The apparatus of claim 15 wherein the source ranker is operative to evaluate whether sources predict facts first.

23. The apparatus of claim 15 wherein the source ranker is operative to evaluate a number of different groups of sources of different types.

24. A computer-based apparatus for extracting predictive information from a collection of stored, machine-readable electronic documents from a plurality of different sources, comprising:
means for accessing at least a subset of the electronic documents each including different machine-readable predictive information about one or more future facts occurring after a publication time for that document, and each with an identified source,
means for extracting the predictive information about the one or more future facts from the accessed documents,
means for acquiring verified information about one or more of the facts, and
means for evaluating a measure of quality of the predictive information extracted from the documents based on the verified information about the facts.
